(19) United States
(12) Patent Application Publication
(10) Pub. No.: US 2006/0180187 A1
(43) Pub. Date: Aug. 17, 2006

(54) Window cleaning apparatus

(75) Inventor: Deven Dallmann, Pleasanton, CA (US)

Correspondence Address: EVERITT BEERS, 5000 HOPYARD ROAD, SUITE 400, PLEASANTON, CA, 94588, US

(73) Assignee: Squeegit, Inc.

(21) Appl. No.: 11/291,202

(22) Filed: Nov. 30, 2005

Related U.S. Application Data
(60) Provisional application No. 60/652,521, filed on Feb. 14, 2005.

(51) Int. Cl. B08B 3/02

(52) U.S. Cl. 134/171; 134/198; 134/184

(57) ABSTRACT

A portable apparatus for holding and dispensing liquid from a container generally comprising a bladder to hold the liquid, a means for introducing liquid into the bladder, an apparatus capable of dispensing liquid from the bladder, generally via a spray nozzle device, and a second apparatus capable of dispensing liquid from the bladder into a receptacle. It is anticipated that this device will have the greatest utility when used as a portable device to assist in the washing of windows.

### RELATED APPLICATIONS

This application claims priority of U.S. Provisional application 60/652521 filed Feb. 2, 2005, which is incorporated by reference in its entirety.

### BACKGROUND OF THE INVENTION

1. Field of the Invention

This invention pertains generally to a portable window cleaning apparatus.

2. Description of Related Art

Despite several recent advances in the art, the most common method of cleaning windows continues to employ the use of a bucket. Prior art window washing buckets are generally used during the task of washing windows, and are generally set on the floor or ground next to the working area. This type of use typically involves a lot of bending down to rinse the squeegee, brush or other implement into the solution. This repeated bending can put a strain on the back of the window washer. Not only is the use of the bucket unwieldy, the user wastes much of their time going back and forth to the bucket. The use of the bucket also tends to cause dripping and spilling.

Furthermore, the liquid in the bucket typically becomes full of dirt from the windows that have been washed. Then, when the user reintroduces the cleaning implement into the bucket, some of this dirt gets back onto it and put back on to the remaining windows. This then causes the user to wash the windows with a dirty implement, and reducing the quality of the cleaning process.

### SUMMARY OF THE INVENTION

The present invention provides improvements to window washing apparatus known in the prior art. The present invention utilizes a backpack style bladder device that holds liquid, including window cleaning solution. As such, the window washer is then free to move about without having to carry a bucket. In one embodiment, the device also comprises an opening in the bladder that allows the user to fill the bladder in a repeatable manner with the desired liquid, such as a window cleaning solution. An embodiment of the invention discloses a sealable opening to the bladder at or near the top of the bladder. The location of the opening is not crucial to the functioning of the device, however there may be advantages to locating the opening at the top of the device, including reducing the potential for leaks. Another embodiment allows for a disposable bladder device wherein the liquid is sealed into the bladder. It is also anticipated that the bladder may include a means for wearing the device, such as a harness and/or shoulder straps attached so that the user's hands remain free.

The apparatus also comprises a means to disperse the liquid as desired by the user. In an embodiment of the invention, the liquid from the bladder is propelled through flexible tubing and into a spray device. In this configuration, the user could trigger dispersal of the desired amount of liquid from the spray device onto the desired location. There are a variety of methods of propelling the liquid from the bladder, including but not limited to a pump, or a pressurized bladder. The pump could utilize a variety of means to propel the liquid, including but not limited to battery power, solar power, or a manual pump.

The instant invention also provides a second apparatus capable of carrying liquid from the bladder. It is anticipated that this second means could carry liquid from the bladder to a receptacle. The receptacle is capable of receiving and holding liquid from the bladder. An embodiment of the invention provides flexible conduit, such as tubing, from the bladder to the receptacle. It is anticipated that the user could place the cleaning implement in the receptacle at various times during the window washing process.

In practice, it has been found that the implement housed in this receptacle is best used when the window surface is not extremely dirty. For example, on exterior windows that have accumulated a large amount of dirt, it is suggested that the user first sprays the window surface with cleaning solution from the spray device, then squeegee the window to remove the bulk of the dirt. The user then has the option of using the mop on the window surface to remove additional dirt. The mop head can be stored in the receptacle while not in use. This process allows the user to determine the level of cleaning, while keeping the mop head or other implement in the receptacle relatively clean.

Additionally, the receptacle allows the user to maintain the cleaning implement in good order while the user performs other tasks. Also, the receptacle and the fluid therein, allow the user to apply cleaning solution to the implement, such as a mop head, brush, or squeegee, so that the implement could be used without the spraying the windows directly. This is especially useful in indoor settings. Also, the receptacle can have one or more additional holding devices that allow it to hold additional implements.

In one embodiment, the receptacle and the means for delivering the liquid to the receptacle, do not require any means to provide additional power or pressure. Natural forces may be allowed to propel the liquid from the bladder to the receptacle. As such, an embodiment of the this second apparatus includes a means for interrupting the flow of liquid from the bladder. This interruption could take place at any point from (and including) the bladder and the receptacle. As an example, an embodiment of the invention includes a valve along the conduit, between the bladder and the receptacle. Another embodiment includes a valve at, or as a part of, the receptacle. Another embodiment includes a valve at, or as a part of, the bladder. Still another embodiment includes a coupling, such as a release coupling, located along the conduit from the bladder to the receptacle.

As discussed above, the invention provides for a receptacle as a component of the second apparatus capable of carrying liquid from the bladder. The valve, discussed above, allows the user to transfer fluid from receptacle to the receptacle in the desired amount. The invention also provides that the receptacle would have the capacity to hold one or more window cleaning implements, such as a squeegee, mop head, and/or brush. The embodiment containing the release coupling will allow the user to remove the receptacle from the apparatus without spillage or dripping.

### BRIEF DESCRIPTION OF THE DRAWINGS

The characteristics and advantages of the invention will become more apparent from the description that follows, by way of non-limiting example, with reference to the accompanying drawings, in which:

FIG. 1 illustrates elements of a window-washing device in accordance with the present invention.

### DETAILED DESCRIPTION OF THE INVENTION

The present invention provides a method and apparatus for use in washing windows that includes a self-contained supply of window washing liquid, as well as the means to apply the liquid to desired locations.

a. Bladder/Reservoir

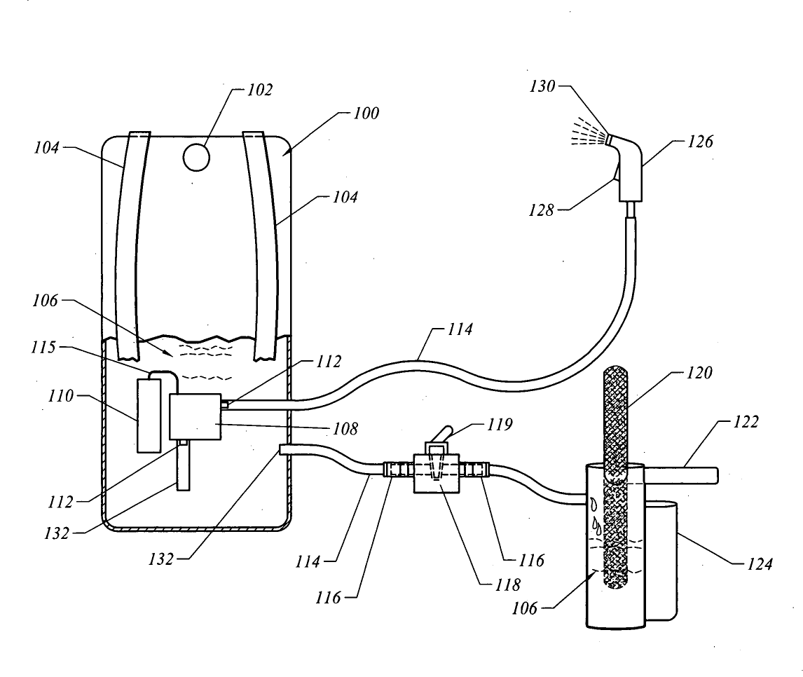

The invention includes a bladder 100 device that is capable of receiving and holding liquid 106. FIG. 1 illustrates a sealable opening 102 wherein liquid can be added or removed from the bladder 100. The bladder may be capable of being filled and re-filled with liquid. However, another embodiment of the bladder 100 allows for a sealed, one time use, bladder/reservoir. In either embodiment, the bladder can be worn or carried by the user. In one embodiment, the bladder includes straps 104 attached to the outside of the bladder 100 that allows the user of the device to wear it like a backpack.

b. Means to Propel Liquid to Sprayer

Attached to the bladder 100 element is a means to apply liquid 106 (e.g. cleaning solution) onto the desired surface. In one embodiment, a pump 108 causes liquid from the bladder 100 to travel into a conduit 114, such as flexible tubing that, in turn, flows into a spray device 126. In this embodiment, the spray device 126 is a hand held sprayer, activated by the user. The pump 108 illustrated in FIG. 1 is powered by a battery 110 located in the bladder 100. Other embodiments include locating the battery 110 and/or pump 108 in various locations, including on the outside of the bladder 100, or in a pocket(s) on the backpack. The location of the battery and/or pump does not affect the usefulness of the invention, and is not limited to the locations suggested herein. The means to power the invention may also include a variety of other devices, including but not limited to a fuel cell, solar power, and a manual pump. The manual pump device, such as a hand pump, may take the form of a typical spray bottle type hand pump. It may also take the form of a manual pump that creates increased air pressure in the bladder, which in turn creates sufficient pressure to cause the liquid to travel to the sprayer.

FIG. 1 also illustrates a means for fluid intake into the pump 108. It is suggested that the location of the fluid intake device 132 be located at or near the bottom of the reservoir, since such a configuration would allow the maximum amount of fluid 106 to be used before the bladder 100 must be re-filled or replaced. Also illustrated in FIG. 1 is a battery-pump connection 115. This connection may take various forms, including wires connecting the two elements, or any other connection that allows power from the battery 110 to be transferred to the pump 108.

FIG. 1 also illustrates flexible tubing 114 attached to the pump 108 (the pump being located in this illustration in the bladder/reservoir 100). The conduit/tubing 114 then attaches to the spray device 126. FIG. 1 also illustrates a means for connecting the tubing 114 to the pump 108. The connecting means shown in this drawing illustrates a hollow connecting device 112 emanating from the pump that allows the tubing to be easily affixed. This connection may take various forms and does not affect the usefulness of the invention, and is not limited to the method illustrated herein. The tubing can be composed of a variety of materials, including, but not limited to, rubber and/or plastic.

FIG. 1 also illustrates a fluid intake duct 132 attached to the pump 108. Again, the connecting means shown in this drawing illustrates a hollow connecting device 112 emanating from the pump that allows the tubing to be easily affixed. This connection may take various forms and does not affect the usefulness of the invention, and is not limited to the method illustrated herein. The fluid intake duct 132 is preferably located, as in FIG. 1, such that it allows fluid to be drawn from the bottom of the bladder 100 when the bladder is in its upright position when worn by a user. This configuration should allow the maximum amount of liquid to be drawn from the bladder before it is emptied.

c. Receptacle and Means to Receive Liquid

FIG. 1 illustrates a second conduit 114 capable of carrying liquid 106 from the bladder 100. FIG. 1 shows a second length of conduit/tubing 114 that is secured to the bladder 100 and receives liquid 106 from the bladder 100. If the this second conduit 114 is located at the lower portion of the bladder, it should not, while the bladder contains sufficient fluid, require any additional means to add pressure or power to the natural flow of the liquid 106 through the conduit 114. The second conduit 114 is secured to a receptacle 113 capable of holding liquid 106. The amount of liquid transferred from the bladder 100 into the receptacle 113 can be controlled by the user through a variety of means. The means for controlling the flow of liquid from the bladder 100 to the receptacle 113 shown in FIG. 1 is through the use of a valve 118 located along the second conduit 114. The valve 118 is capable of staunching the flow of liquid 106 through the conduit 114. FIG. 1 illustrates a switch 119 on the valve 118 that allows the user to control the flow of liquid 106 through the conduit 114. Also shown in FIG. 1 is a release coupling 116 that, in this embodiment, allows the user to remove the receptacle 113, and any remaining conduit 114 located between the release coupling 116 and the receptacle 113, from the other elements of the apparatus. The location of the valve 118, as well as the release coupling 116, can be located at a variety of locations. For instance, the valve 118 and release coupling 116 can be located at, or made part of, the receptacle 113. In another embodiment, the valve 118 and release coupling 116 can be located at, or made part of, the bladder 100. In the embodiment shown in FIG. 1, the valve 118 and release coupling 116 are located along the tubing 114 between the bladder 100 and the receptacle 113.

FIG. 1 illustrates a receptacle 113 that can receive and hold liquid 106 from the bladder/reservoir. The receptacle 113 is capable of holding a mop head 120. In the embodiment shown in FIG. 1, a portion of the mop head 120 is contained in the receptacle 113, while the remainder of the mop head 120 rests above the receptacle 113. The handle 122 of the mop shown in FIG. 1 is at a right angle to the mop head 120 and rests on a depression along edge of the receptacle 113. The depression along the top edge of the receptacle 113 acts to limit the movement of the mop while not in use, while at the same time maintaining easy access to the user.

Another feature of the receptacle 113 shown in FIG. 1 is an external holding element 124 that allows the user to store one or more additional implements, such as a squeegee. This additional apparatus may be located on the receptacle 113 and does not necessarily require the introduction of fluid. This external holding element 124 allows the user to maintain possession of multiple implements, while allowing the user to keep their hands free.

What is claimed:

1. A portable apparatus for holding and dispensing liquid from a container comprising:
a. A bladder;
b. A first apparatus capable of dispensing liquid from the bladder, this apparatus comprising:
i. A means for inducing the liquid from the bladder;
ii. A spray device; and
iii. A conduit capable of carrying liquid from the bladder to the spray device;
c. A second apparatus capable of dispensing liquid from the bladder, this second apparatus comprising:
i. A receptacle capable of receiving liquid from the bladder;
ii. A conduit capable of carrying liquid from the bladder to the receptacle; and
iii. A means for interrupting the flow of liquid from the bladder to the receptacle.

2. The apparatus of claim 1, further comprising a means for introducing liquid into the bladder.

3. The apparatus of claim 2, wherein the means for introducing liquid into the bladder comprises a sealable opening in the bladder.

4. The apparatus of claim 1, wherein the means for inducing the liquid from the bladder comprises a pressurized bladder.

5. The apparatus of claim 1, wherein the means for inducing the liquid from the bladder comprise:
a. A pump; and
b. A means for powering the pump.

6. The apparatus of claim 5, wherein the means for powering the pump comprise a battery.

7. The apparatus of claim 5, wherein the means for powering the pump comprise a fuel cell.

8. The apparatus of claim 5, wherein the means for powering the pump utilizes solar power.

9. The apparatus of claim 1, wherein the means for delivering the cleaning solution from the bladder to the receptacle comprises the following:
a. A tube from the bladder to the receptacle;

10. The apparatus of claim 1, wherein the means for interrupting the flow of liquid from the bladder to the receptacle further comprises:
a. A valve located in the conduit between the bladder and the receptacle.

11. The apparatus of claim 1, wherein the means for interrupting the flow of liquid from the bladder to the receptacle further comprises:
a. A valve located at the receptacle.

12. The apparatus of claim 1, wherein the means for interrupting the flow of liquid from the bladder to the receptacle further comprises:
a. A valve located at the bladder.

13. The apparatus of claim 1, wherein the conduit capable of carrying liquid from the bladder to the receptacle further comprises a release coupling.

14. The apparatus of claim 1, wherein the spray device further comprises:
a. A trigger mechanism on the spray device.

15. The apparatus of claim 1, wherein the receptacle further comprises an external holding element capable of holding a plurality of window washing related implements.
